(19) United States
(12) Patent Application Publication
(10) Pub. No.: US 2008/0114527 A1
(43) Pub. Date: May 15, 2008

(54) Method of controlling fuel injection during start mode on a diesel engine

(76) Inventors: James Edward McCarthy, Canton, MI (US); Mark Allen Zurawski, Northville, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/599,577

(22) Filed: Nov. 14, 2006

(51) Int. Cl. F02D 45/00

(52) U.S. Cl. 701/113

(57) ABSTRACT

A method and system for repeatable diesel engine starts during a wide range of conditions that decouples fueling requirements during engine starting and normal engine operation.

### STATEMENT REGARDING FEDERALLY SPONSORED RESEARCH OR DEVELOPMENT

This invention was made with Government support under Contract No. DE-FCO5-OOOR22805. The Government has certain rights to this invention.

### BACKGROUND OF THE INVENTION

Cold engine starting has been a continuing challenge in the heavy duty diesel engine industry. Regardless of whether an engine utilizes Electronic Fuel Injection Units or common rail technology, cold starting has usually consisted of admitting fuel into the engine cylinders based upon torque load or according to a start strategy contained within data tables in the electronic control module (ECM). These approaches have not been entirely satisfactory as repeatability of starting is difficult, depending upon ambient conditions. In the past, these challenges have been minimized by continuing to run the engine in idle mode during cold weather when the vehicle is not in use so that starting is not a concern in cold weather. This approach has resulted in a fuel efficiency concern, as the idling engine consumes fuel without doing any work to bring economic return to the operator.

Accordingly, there is a need for a cold weather start strategy for heavy duty diesel engines that adjusts for ambient weather conditions to produce repeatable cold weather starts and which does not subject the operator to a fuel economy penalty.

### BRIEF SUMMARY OF THE INVENTION

The present invention relates to a method for starting an electronically controlled internal combustion engine having at least one cylinder and an electronic control module (ECM). The engine may be equipped with a common rail or electronic fuel delivery system. The method comprises cranking the engine, determining the engine oil temperature, using the oil temperature and engine speed to determine the quantity of fuel to be delivered to each cylinder independent of engine torque, and delivering the fuel to each cylinder. The quantity of fuel is determined by reference to a look-up table contained within said ECM that contains fuel delivery specified as a function of engine speed and oil temperature. The start mode logic further permits fuel to be injected into the combustion chamber having units of mm³/cylinder/cycle. The delivery of fuel is independent of engine torque and provides repeatable starts over a wide range of oil temperature conditions, i.e. from −40° C. to about 155° C., and engine speeds. The delivery of fuel will taper off as the engine speed increases and oil temperature increases. Once the engine has assumed a normal idling or running condition, a normal fuel strategy based upon engine torque demand is utilized.

The method further includes fuel delivery strategies based upon torque in a data look-up table in the ECM to permit fuel delivery based upon torque to be altered independent of the quantity of fuel per cycle delivered during start.

Various other advantages and features of the present invention will be readily apparent to one of ordinary skill in the art upon a reading of the detailed description of the preferred embodiments and a review of the accompanying drawings.

### BRIEF DESCRIPTION OF THE DRAWINGS

FIG. 1 is a schematic representation of a diesel engine with a common rail fuel system in a heavy duty vehicle.

FIG. 2 is a flowchart of the steps in the method according to the present invention.

FIG. 3 is a representative starting fuel per cycle curve at normal engine oil temperature.

FIG. 4 is a representative fuel delivery curve at starting using the fuel strategies of the present invention.

### DETAILED DESCRIPTION OF THE PREFERRED EMBODIMENT(S)

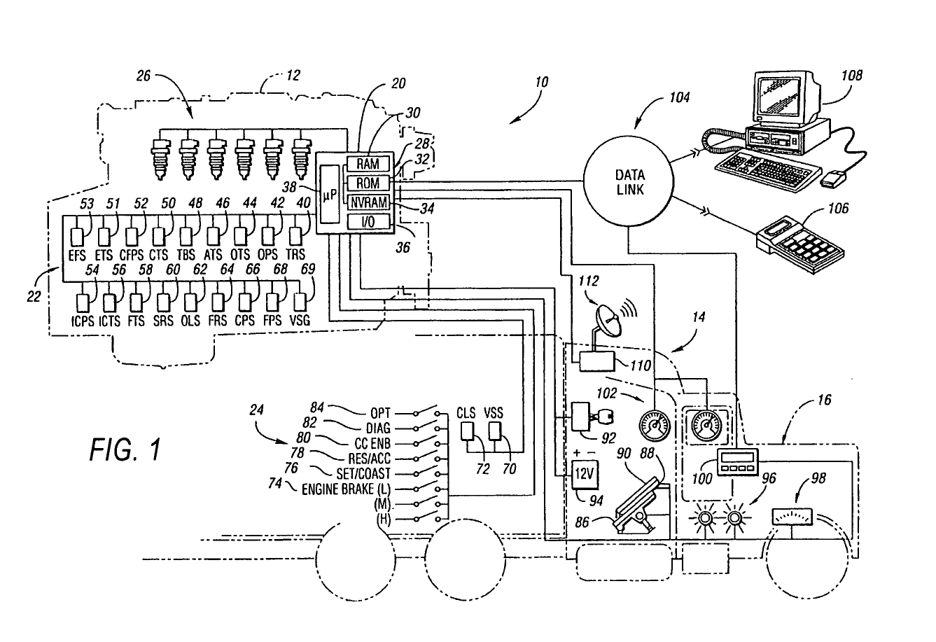

Turning now to the drawings wherein like numerals depict like structures, and particularly to FIG. 1, there is shown a schematic/block diagram illustrating operation of a system or method for controlling multiple fuel injections for an internal combustion engine having a common rail fuel distribution system according to one embodiment of the present invention. As will be appreciated by those of ordinary skill in the art, the multiple fuel injections include what is typically referred to as a main injection in addition to a pilot injection occurring before the main injection and/or one or more post injections occurring after the main injection. While the main injection is generally a longer duration injection that delivers a fuel quantity greater than the pilot and post injections, the principles of the present invention apply to other applications and operating conditions regardless of the relative durations of the injection events and corresponding quantities of fuel delivered.

Representative system 10 includes a multi-cylinder compression ignition internal combustion engine, such as a diesel engine 12, which may be installed in a vehicle 14 depending upon the particular application. In one embodiment, vehicle 14 includes a tractor/semi-trailer 16. Diesel engine 12 is installed in tractor/semi-trailer 16 and interfaces with various sensors and actuators located on engine 12, and tractor/semi-trailer 16 via engine and vehicle wiring harnesses. In other applications, engine 12 may be used to operate industrial and construction equipment, or in stationary applications for driving generators, compressors, and/or pumps and the like.

An electronic engine control module (ECM) 20 receives signals generated by engine sensors 22 and vehicle sensors 24 and processes the signals to control engine and/or vehicle actuators such as fuel injectors 26, for example. ECM 20 preferably includes computer-readable storage media, indicated generally by reference numeral 28 for storing data representing instructions executable by a computer to control engine 12, and in particular the timing and quantity of fuel injected into the cylinders in accordance with the present invention. Computer-readable storage media 28 may also include calibration information in addition to working variables, parameters, and the like. In one embodiment, computer-readable storage media 28 include a random access memory (RAM) 30 in addition to various non-volatile memory such as read-only memory (ROM) 32, and non-volatile memory (NVRAM) 34. Computer-readable storage media 28 communicate with a microprocessor 38 and input/output (I/O) circuitry 36 via a standard control/address bus. As will be appreciated by one of ordinary skill in the art, computer-readable storage media 28 may include various types of physical devices for temporary and/or persistent storage of data which includes solid state, magnetic, optical, and/or combination devices. For example, computer readable storage media 28 may be implemented using one or more physical devices such as DRAM, PROMS, EPROMS, EEPROMS, flash memory, and the like. Depending upon the particular application, computer-readable storage media 28 may also include floppy disks, CD ROM, DVD, and the like.

In a typical application, ECM 20 processes inputs from engine sensors 22, and vehicle sensors/switches 24 by executing instructions stored in computer-readable storage media 28 to generate appropriate output signals for control of engine 12 via corresponding actuators. In one embodiment of the present invention, engine sensors 22 include a timing reference sensor (TRS) 40 which provides an indication of the crankshaft position and may be used to determine engine speed, preferably in revolutions per minute (rpm). As described in greater detail below, the crankshaft position is also preferably used to determine the beginning of injection (BOI) for the pilot injection (when active) and the main injection. An oil pressure sensor (OPS) 42 and oil temperature sensor (OTS) 44 are used to monitor the pressure and temperature of the engine oil, respectively.

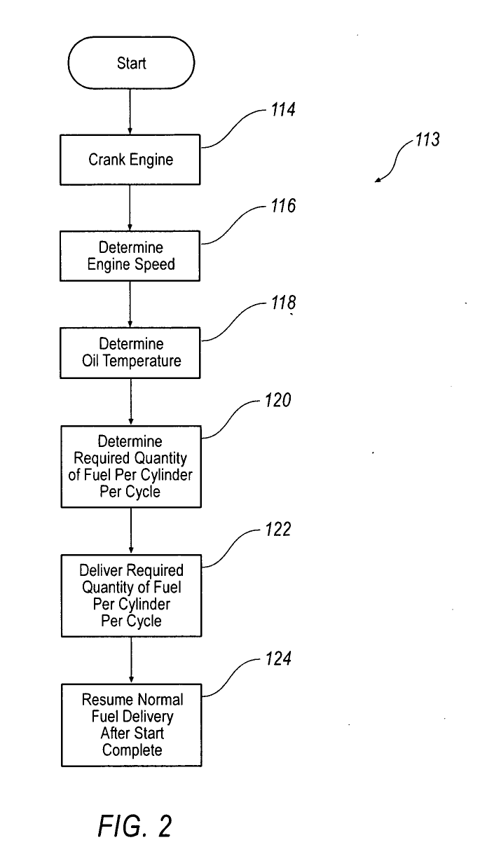

An air temperature sensor (ATS) 46 is used to provide an indication of the current intake or ambient air temperature. A turbo boost sensor (TBS) 48 is used to provide an indication of the boost pressure of a turbocharger which is preferably a variable geometry or variable nozzle turbocharger. As known by those of ordinary skill in the art, TBS 48 may also be used to provide an indication of the intake manifold pressure. Coolant temperature sensor (CTS) 50 is used to provide an indication of the coolant temperature. One or more fluid temperatures, such as the oil temperature, air temperature, coolant temperature, and the like may be used to determine a desired fuel delivery during start as described in greater detail with reference to FIG. 2.

Depending upon the particular engine configuration and application, various additional sensors may be included. For example, engines which utilize exhaust gas recirculation (EGR) preferably include an EGR temperature sensor (ETS) 51 and an EGR flow sensor (EFS) 53.

Common rail fluid distribution systems may include one or more pressure sensors to detect the pressure within the common rail and provide a corresponding signal to the pressure controller within the ECM 20. As previously described, common rail systems may be used to distribute fuel to the fuel injectors that are controlled by ECM 20. The common rail fuel system preferably includes a corresponding fuel pressure sensor (CFPS) 52. Similarly, an intercooler coolant pressure sensor (ICPS) 54 and temperature sensor (ICTS) 56 may be provided to sense the pressure and temperature of the intercooler coolant. Engine 12 also preferably includes a fuel temperature sensor (FTS) 58 and a synchronous reference sensor (SRS) 60. SRS 60 provides an indication of a specific cylinder in the firing order for engine 12. This sensor may be used to coordinate or synchronize control of a multiple-engine configuration such as used in some stationary generator applications.

Engine 12 may also include an oil level sensor (OLS) 62 to provide various engine protection features related to a low oil level. A fuel restriction sensor (FRS) 64 may be used to monitor a fuel filter and provide a warning for preventative maintenance purposes. A fuel pressure sensor (FPS) 68 provides an indication of fuel pressure to warn of impending power loss and engine fueling. Similarly, a crankcase pressure sensor (CPS) 66 provides an indication of crankcase pressure which may be used for various engine protection features by detecting a sudden increase in crankcase pressure indicative of an engine malfunction.

System 10 preferably includes various vehicle sensors/switches 24 to monitor vehicle operating parameters and driver input used in controlling vehicle 14 and engine 12. For example, vehicle sensors/switches 24 may include a vehicle speed sensor (VSS) 70, which provides an indication of the current vehicle speed. A coolant level sensor (CLS) 72 monitors the level of engine coolant in a vehicle radiator. Switches used to select an engine operating mode or otherwise control operation of engine 12 or vehicle 14 may include an engine braking selection switch 74 which preferably provides for low, medium, high, and off selections, cruise control switches 76, 78, and 80, a diagnostic switch 82, and various optional, digital, and/or analog switches 84, such as a high idle switch, for example. ECM 20 also receives signals associated with an accelerator or foot pedal 86, a clutch 88, and a brake 90. ECM 20 may also monitor position of a key switch or ignition switch 92 and a system voltage provided by a vehicle battery 94 to determine current operating conditions and control engine 12 and/or vehicle 14.

ECM 20 may communicate with various vehicle output devices such as status indicators/lights 96, analog displays 98, digital displays 100, and various analog/digital gauges 102. In one embodiment of the present invention, ECM 20 utilizes an industry standard data link 104 to broadcast various status and/or control messages which may include engine speed, oil temperature, accelerator pedal position, vehicle speed, and the like. Preferably, data link 104 conforms to SAE J1939 and SAE J1587 to provide various service, diagnostic, and control information to other engine systems, subsystems, and connected devices such as display 100. Preferably, ECM 20 includes control logic to determine current engine and ambient operating conditions to select corresponding gains for a PID and/or feed forward pressure controller to control the pressure within one or more common rail fluid distribution systems, as described in greater detail with reference to FIG. 2. ECM 20 preferably determines at least a current operating mode and receives information concerning oil temperature and engine speed and engine torque demand to determine a desired rail pressure setpoint. The rail pressure setpoint may then be used by a suitable rail pressure controller or governor within ECM 20 to control one or more fuel pumps to supply the desired common rail pressure.

A service tool 106 may be periodically connected via data link 104 to program selected parameters stored in ECM 20 and/or receive diagnostic information from ECM 20. Likewise, a computer 108 may be connected with the appropriate software and hardware via data link 104 to transfer information to ECM 20 and receive various information relative to operation of engine 12, and/or vehicle 14. Similarly, transceiver 110 and antenna 112 may be used to wirelessly send and/or receive program, diagnostic, or other information.

Block diagrams illustrating operation of one embodiment for a system or method for controlling fuel injections during start in a diesel engine equipped with a common rail fluid distribution system according to the present invention are shown in FIG. 2. As will be appreciated by one of ordinary skill in the art, the block diagrams represent control logic which may be implemented or effected in hardware, software, or a combination of hardware and software. The various functions are preferably effected by a programmed microprocessor, such as included in the DDEC controller manufactured by Detroit Diesel Corporation, Detroit, Mich. Of course, control of the engine/vehicle and/or associated components may include one or more functions implemented by dedicated electric, electronic, or integrated circuits or controllers. As will also be appreciated by those of skill in the art, the control logic may be implemented using any of a number of known programming and processing techniques or strategies and is not limited to the particular order or sequence illustrated. For example, interrupt or event driven processing is typically employed in real-time control applications, such as control of an engine or vehicle rather than a purely sequential strategy as illustrated. Likewise, parallel processing, multi-tasking, or multi-threaded systems and methods may be used to accomplish the objectives, features, and advantages of the present invention. The invention is independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the features and advantages of the present invention. The illustrated functions may be modified, or in some cases omitted, without departing from the spirit or scope of the present invention.

In various embodiments of the present invention, the control logic illustrated is implemented primarily in software and is stored in computer readable storage media within the ECM. As one of ordinary skill in the art will appreciate, various control parameters, instructions, and calibration information stored within the ECM may be selectively modified by the vehicle owner/operator while other information is restricted to authorized service or factory personnel. The computer readable storage media may also be used to store engine/vehicle operating information and diagnostic information. Although not explicitly illustrated, various steps or functions are repeatedly performed depending on the particular function and the type of processing employed.

FIG. 2 is a flowchart, representing the method 113 of the present invention. During crank mode 114, step 116 is determining the engine speed and step 118 is determining the engine oil temperature. Step 120 is determining the required fuel quantity to be delivered to each cylinder per cycle. Step 122 is delivering the required quantity of fuel per cylinder to start the engine. When the engine speed exceeds a preset value, for example, about 650 rpm, and engine oil temperature has risen to a preset value of about 40 to 100° C., step 124 resumes normal fuel delivery after start is complete by reference to a fuel delivery strategy based upon engine torque.

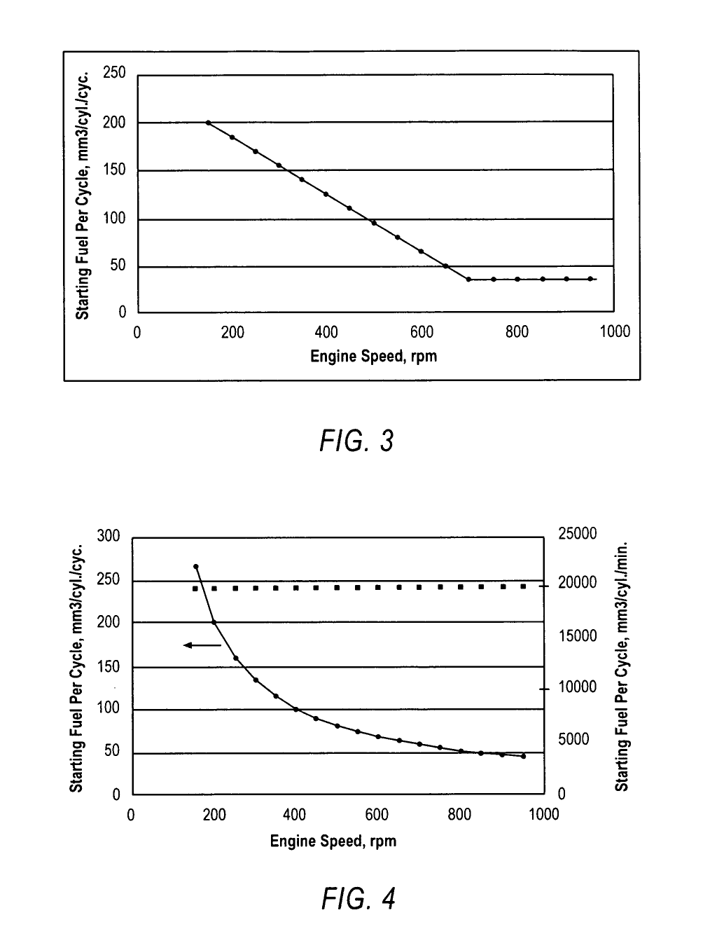

The ECM contains fuel injection logic that includes a look up table of desired fuel quantity values as a function of engine speed and oil temperature. By way of explanation, engine speed is incremented from about 150 rpm to about 950 rpm to encompass all engine speeds that are possible during start mode with a 50 rpm resolution. Engine oil temperature is selected to span from about −40° C. to about 155° C. Those skilled in the art will recognize that any range of engine oil temperature may be selected for these purposes. Starting fuel per cycle values may be based upon normal oil temperature values. It is known that for normal starting, additional fuel is required to start the engine at low speeds. FIG. 3 illustrates a representative starting fuel per cycle curve as a function of engine speed for normal engine oil temperatures, in a range of from about 40° C. to 100° C.

FIG. 4 shows a starting fuel cycle curve as a function of engine speed having an equal injection rate of about 20,000 mm³/cyl./min. Typically, the fuel strategy values used during start up are determined by converting engine oil temperature and engine speed into a requested torque value percent. These values are used with requested torque value, fuel quantity and injector maps to specify the fueling requirement during the start mode. As a result, the start_extra_torque table is linked directly to these normal fuel tables.

The present invention decouples the fueling requirement during engine starting and normal operation. One result of this is that engine power ratings may be adjusted without affecting the engine start mode strategy to retain reliable and repeatable engine starts over a wide range of conditions. Indeed, it has been determined that fuel profiling is an advantage to said engine starts and results in consistent starting and reduced white smoke during cold temperature starts. The present invention converts the total fuel per cycle (FPC) and engine speed inputs to a required fueling during engine start mode. On possible way to achieve this to provide a relay and a switch that may be utilized to determine whether the total fuel per cycle during normal engine operation should be carried through or whether the engine should operate according to the a lookup table which contains the start mode strategies. In such a system, generally, when engine speed is less that about 650 rpm, the look up table passes through the switch and the engine operates according to the start up strategy. When the engine speed is greater than about 650 rpm, the normal fueling strategies based upon engine torque are employed. The present invention permits for all the torque based components of a fueling strategy to be altered independent of the starting fueling strategies.

While one preferred embodiment has been described, many variations and modifications will become apparent to one of ordinary skill in the art without departing from the scope or spirit of the invention as set forth in the appended claims.

What is claimed as new and desired to be protected by Letters Patent of the United States is:

1. A method for starting an electronically controlled internal combustion engine having at least one cylinder and an electronic control module (ECM), comprising:
a) cranking engine;
b) determining engine speed;
c) determining engine fluid temperature;
d) determining the quantity of fuel per cycle to be delivered to each cylinder independent of engine torque; and
e) delivering the fuel to each cylinder.

2. The method for starting an electronically controlled internal combustion engine having at least one cylinder and an electronic control module (ECM) of claim 1, wherein said fuel is delivered to said cylinder via a common rail system.

3. The method for starting an electronically controlled internal combustion engine having at least one cylinder and an electronic control module (ECM) of claim 1, wherein said fuel is delivered to a said cylinder an electronic controlled injection unit.

4. The method for starting an electronically controlled internal combustion engine having at least one cylinder and an electronic control module (ECM) of claim 1, wherein said quantity of fuel is determined by reference to a look-up table contain within said ECM.

5. The method for stating an electronically controlled internal combustion engine having at least one cylinder and an electronic control module (ECM) of claim 1, wherein said delivery of fuel during said start is independent of delivery of fuel during normal engine operation.

6. The method for starting an electronically controlled internal combustion engine having at least one cylinder and/or electronic control module (ECM) of claim 1, further including fuel delivery strategies based upon torque in a data look-up table the ECM to permit fuel delivery based upon torque to be altered independent of the quantity of fuel per cycle delivered during start strategy.

7. The method for starting an electronically controlled internal combustion engine having at least one cylinder and an electronic control module (ECM) of claim 1, wherein fuel delivery during start decreases as engine speed increases.

8. The method for starting an electronically controlled internal combustion engine having at least one cylinder and an electronic control module (ECM) of claim 1, wherein additional fuel is delivered to start the engine at low engine speed, said fuel delivery decreases as engine speed increases until normal engine speed and oil temperature is achieved, at which point fuel delivery is controlled based upon engine torque requirements.

9. The method for starting an electronically controlled internal combustion engine having at least one cylinder and an electronic control module (ECM) of claim 1, wherein said engine fluid is engine oil.

10. The method for starting an electronically controlled internal combustion engine having at least one cylinder and an electronic control module (ECM) of claim 1, wherein said engine fluid is engine coolant.

11. The method for starting an electronically controlled internal combustion engine having at least one cylinder and an electronic control module (ECM) of claim 1, wherein said engine fluid is ambient air entering the engine.

12. The method for starting an electronically controlled internal combustion engine having at least one cylinder and one electronic central module (ECM) of claim 1, wherein said method permits consistent starting and reduced white smoke during cold temperature starts.

13. A computer readable storage medium having stored data representing instructions executable by a computer to control a multiple cylinder internal combustion engine, the computer readable storage medium comprising:
a) instructions for delivering fuel during start based upon engine speed and engine oil temperature, and
b) instructions for delivery fuel during operating of the engine based upon engine torque requirements.

14. The computer readable storage medium of claim 13, wherein the instructions for delivering fuel during start are contained in one data look-up table and the instructions for delivering fuel during normal engine operation are contained in another data look-up table.

15. The computer readable storage medium of claim 13, wherein the fuel delivering during start decreases as engine speed increases and oil temperature increases until normal engine speed and oil temperature are achieved, at which time fuel delivery is controlled by engine torque demands.
